(19) United States
(12) Patent Application Publication
(10) Pub. No.: US 2012/0297652 A1
(43) Pub. Date: Nov. 29, 2012

(54) DEVICE AND METHOD FOR ATTACHING AN ID-MARKER TO A PRODUCTION PIPE

(75) Inventor: Halvor Halvorsen, Stavanger (NO)

(73) Assignee: TRAC-ID SYSTEMS AS, Stavanger (NO)

(21) Appl. No.: 13/509,561

(22) PCT Filed: Nov. 12, 2010
(86) PCT No.: PCT/NO10/00411

§ 371 Date: Aug. 8, 2012

(30) Foreign Application Priority Data
Nov. 12, 2009 (NO) 20093334

(51) Int. Cl. G09F 3/08; B23P 11/00

(52) U.S. Cl. 40/661.05; 29/525.01; 29/525.11

(57) ABSTRACT

A device and a method for attaching an ID marker to a cylindrical object further characterized by that said marker is placed into a fitting, said fitting has a cylindrical shape, said fitting fits around said cylindrical object.

### TECHNICAL FIELD

The present invention regards a device, and a method, for attaching an identification tag to a cylindrical object, more particularly how to attach an RFID tag to a pipe or tubing used in production of oil.

### BACKGROUND OF THE INVENTION

Modern oil and gas drilling and production equipment is set under a vast and ridged demand for controlling the age of and the wear on the drill pipes, production tubing and similar, and for keeping track of the maintenance done on the pipes. The present method for controlling such information is either by reading of manually an identification number physically printed on the pipe itself.

Another method is to attach an ID marker, e.g. an RFID marker, to the drill pipe by drilling a slot into the pipe and attaching the marker in the hole.

Drilling a slot for the ID marker or printing an identification number in the material of the pipes or tubing is a method that can only be used on drill pipes since they have a wall thickness that makes it possible to drill in without destroying the structure of the pipe or tubing.

An example of such a solution is patent application number WO 0079239 A1 where it is described a method for drilling a slot or a hole in the pipe itself into which the ID marker is placed.

Further it is shown in U.S. Pat. No. 6,347,292 B1 a method for marking a drill pipe by either drilling a slot into the material of the pipe or by adding a collar around the pipe into which the ID marker is placed. This collar is fitted around the pipe and tightened by screwing two parts of the collar together.

In U.S. Pat. No. 7,014,100 B2 it is shown an alternative way of adding an ID marker to the drill pipe. Here an antenna is placed in between the joints of two pipes. The antenna broadcasts a signal unique to each antenna.

The problems with these solutions are that they either only can be used on pipes with a wall thickness over a certain level since production pipes, production tubing or similar, has a low wall thickness not allowed to either print or weaken in any way.

Or they are not strong enough or suitable for the harsh climate that exists in a drill hole.

The present way of marking pipes or tubing of these dimensions is to paint the numbers on the pipe or tubing itself. The problem with this method is that the paint is easily worn off when the pipe or tubing is in use.

### SUMMARY

It is therefore an objective of the present invention, as stated in the independent claims and the thereto belonging dependent claims, to solve the problems mentioned above.

The way of solving these problems is to place a fitting, usually in the form of a metal ring, containing an ID marker, preferably in the form of an RFID marker, around the pipe or tubing and attach this ring to the pipe or tubing.

The ring is placed around the pipe or tubing and shrunk to fit and it has a hole or a slot in it into which the ID marker is placed.

### SHORT DESCRIPTION OF THE DRAWINGS

FIG. 1 shows a cross section of an embodiment of the present invention.

FIG. 2 shows a perspective view of the same embodiment of the present invention as shown in FIG. 1.

FIG. 3 is a perspective view of the same embodiment where the present invention is mounted on the pipe or tubing.

### DETAILED DESCRIPTION

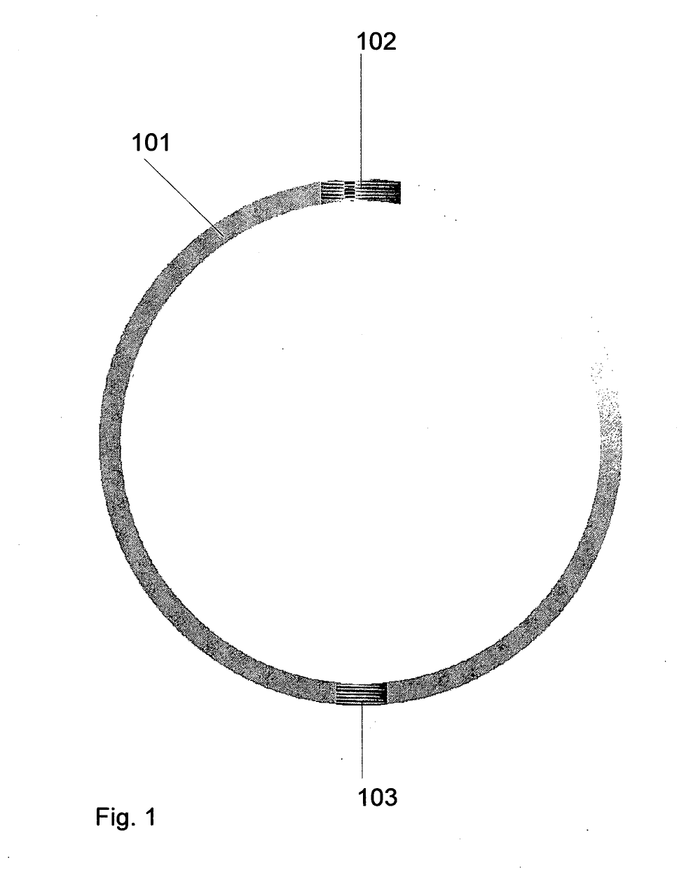

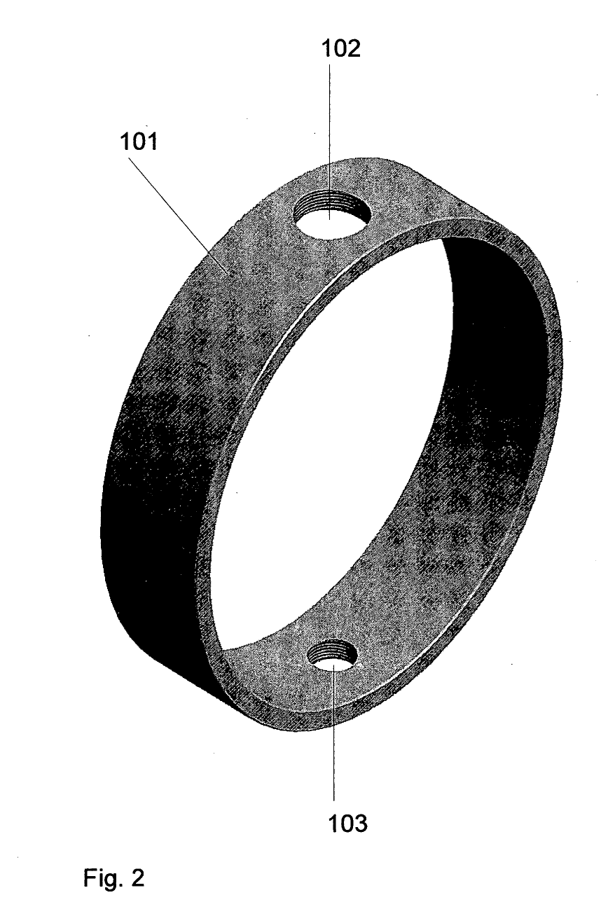

FIGS. 1 and 2 shows a preferred embodiment of the present invention. It is presented a ring or a band 101 preferably made of metal. The metal ring 101 has a flat, wide edge. The edge has a thickness of such a size that it can hold an ID marker. A hole 102 is placed on the edge of the metal ring 101. The hole 102 is preferably placed at the centre of the width of the ring 101.

The hole 102 can either penetrate the edge of the ring 101 entirely or only partially. The hole 102 is dimensioned in such a way that an ID marker can be fitted in it.

A preferred way of placing the ID marker in the metal ring 101 is to make the hole 102 threaded. This makes it possible to screw the ID marker into the metal ring 101.

Further it is possible to place the ID marker in the metal ring 101 by drilling a hole 102 in the metal ring 101 into which an ID marker is placed. Further the holes 102 can be closed with e.g. a set screw. The hole 102 is further provided with a small window making it possible to read the ID marker.

The metal ring 101 is provided with another hole 103. This hole 103 can be used for placing a galvanic anode. This prevents corrosion of the metal ring 101 and the pipe or tubing.

In other embodiments of the present invention the number of holes 102, 103 can vary either having no second hole 103, or the metal ring 101 can be fitted with several smaller holes.

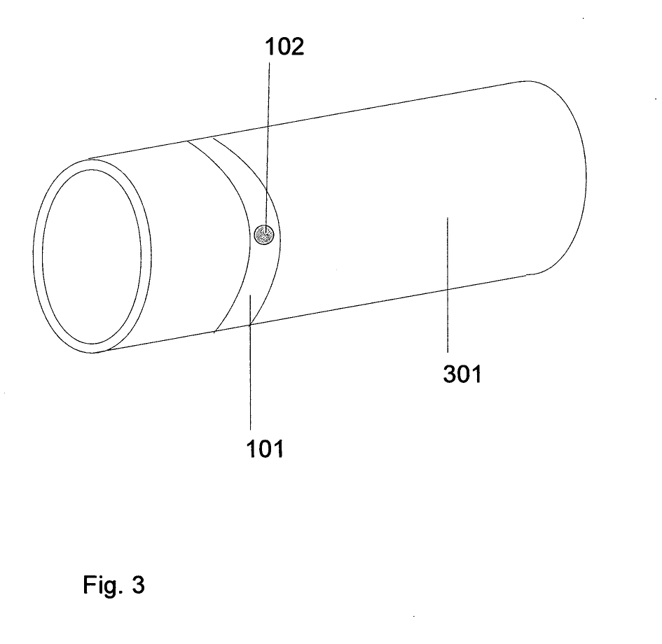

FIG. 3 shows an embodiment of the invention where the metal ring 101 is mounted to the pipe or tubing 301.

It is shown that the metal ring 101 can be fitted anywhere on the pipe or tubing.

The method of connecting the metal ring 101 to the pipe or tubing is to shrink the metal ring 101 so that it fits the pipe or tubing. This can be done either thermally or mechanically. A protective and/or electrically insulating material can be installed between the metal ring 101 and the pipe wall for further protection and/or corrosion inhibition of the pipe.

Further the ID marker can also be fitted in the coupling between two sections of pipes or tubing. This can be done either by adding a section to an existing coupling or, if possible, it can be drilled a holes 102 in the coupling into which the ID marker is attached. The way of attaching the ID marker to the coupling can be done in the same way as in the embodiment of the metal ring 101.

1. A device (101) for attaching an ID marker to a cylindrical object (301) in the form of a production pipe or production tubing (301), said device (101) consists of a fitting (101), said fitting (101) has a cylindrical shape, said fitting (101) fits around said cylindrical object (301) and said ID marker is placed in said fitting (101) and further characterized by that said fitting (101) has a continuous shape, said fitting (101) is shrunk to fit said cylindrical object (301).

2. A device (101) as described in claim 1 further characterized by that said fitting (101) is a ring of metal (101).

3. A device (101) as described in claim 1 further characterized by that said ID marker is a RFID marker.

4. A device (101) as described in claim 2 further characterized by that said ring of metal (101) can attach a galvanic anode.

5. A device (101) as described in claim 1 further characterized by that said cylindrical object (301) is a production pipe or production tubing.

6. A device (101) as described in claim 1 further characterized by that said pipe or tubing (301) is a pipe for use in oil and gas exploration and production.

7. A device (101) as described in claim 1 further characterized by that an insulating material can be installed between the metal ring 101 and the wall of the pipe (301).

8. A method of attaching an ID marker to a cylindrical object (301) further characterized by that a fitting (101) is placed around said cylindrical object (301), said fitting (101) is attached to said cylindrical object (301), said ID marker is attached to said fitting.

9. A method as described in claim 8, further characterized by that said fitting (101) is a ring of metal (101).

10. A method as described in claim 9, further characterized by that said ring of metal (101) has at least one hole (102) into which said ID marker is placed.

11. A method as described in claim 10, further characterized by that said ID marker is screwed into said hole (102).

12. A method as described in claim 9, further characterized by that said ring of metal (101) is attached to said cylindrical object (301) by shrinking.

13. A method as described in claim 12, further characterized by that said method of shrinking can be either thermal or mechanical.

14. A method as described in claim 9, further characterized by that said ring of metal (101) can be a coupling between two pipes or two pieces of tubing.

15. A method as described in claim 9, further characterized by that insulating material can be installed between the metal ring (101) and the pipe wall.
